(19) United States
(12) Patent Application Publication
(10) Pub. No.: US 2010/0182279 A1
(43) Pub. Date: Jul. 22, 2010

(54) DISPLAY SYSTEM HAVING OPTICAL COORDINATE INPUT DEVICE

(75) Inventor: Noriyuki Juni, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/638,416

(22) Filed: Dec. 15, 2009

(30) Foreign Application Priority Data
Jan. 20, 2009 (JP) 2009-009535
Nov. 18, 2009 (JP) 2009-262806

(51) Int. Cl. G06F 3/042

(52) U.S. Cl. 345/175

(57) ABSTRACT

In a display device having a coordinate input device in a display system, light beams emitted from all the plurality of light emitting devices are arranged in an X-Y matrix inside a rectangular coordinate input area. When light shielding signals are detected through a light receiving device in X direction and also through a light receiving device in Y direction, the optical coordinate input device obtains the position coordinate of an intersection of a line from the light receiving device in X direction and a line from the light receiving device in Y direction, and displays position information on the display screen in accordance with thus-obtained position coordinate.

### CROSS-REFERENCE TO RELATED APPLICATIONS

This application claims priority from each of Japanese Patent Application No. 2009-009535, filed on Jan. 20, 2009 and Japanese Patent Application No. 2009-262806, filed on Nov. 18, 2009, the contents of which are hereby incorporated by reference.

### BACKGROUND OF THE INVENTION

1. Field of the Invention

The present invention relates to a display system having an optical coordinate input device on a display screen thereof. More particularly, the coordinate input device has a rectangular coordinate input area constituted by two opposite sides in horizontal direction (X direction) and two opposite sides in vertical direction (Y direction). A plurality of light emitting devices are arranged on one side of the two opposite sides in horizontal direction (in X direction) while a plurality of light receiving devices are arranged on the other side thereof in a state where each of the plurality of light receiving devices faces each of the plurality of light emitting devices. At the same time, a plurality of light emitting devices are arranged on one side of the two opposite sides in vertical direction (in Y direction) while a plurality of light receiving devices are arranged on the other side thereof in a state where each of the plurality of light receiving devices faces each of the plurality of light emitting devices. In the coordinate input device, light beams emitted from all the plurality of light emitting devices are arranged in an X-Y matrix inside the rectangular coordinate input area. When light shielding signals are detected through a light receiving device in X direction and also through a light receiving device in Y direction, the optical coordinate input device obtains the position coordinate of an intersection of a line from the light receiving device in X direction and a line from the light receiving device in Y direction, and displays position information on the display screen in accordance with thus-obtained coordinates.

2. Description of the Related Art

There have been conventionally proposed a variety of coordinate input devices which are disposed on display devices such as a liquid crystal display and detect positions touched on the display devices with fingers and the like. The types of the coordinate input devices include a resistive film type, a surface acoustic wave type, an optical (infrared) type, an electromagnetic induction type, an electrostatic capacitance type and the like. Among them, for instance, an optical-type coordinate input device has high light transmittance and superiority in transparency and reliability. Therefore, optical-type coordinate input devices have been widely employed in apparatuses such as automatic teller machines in banks or ticket vending machines in railroad stations.

Among this type of optical-type coordinate input devices, for instance, in an optical-type coordinate input device disclosed in U.S. Pat. No. 5,914,709, light beams are arranged in an X-Y matrix by means of light-emitting optical waveguides in a coordinate input area. At the same time, the optical-type coordinate input device receives the light beams emitted from the light-emitting optical waveguides by means of light-receiving optical waveguides, and when a light beam is shielded in the coordinate input area with an object such as a finger or a pen, the optical-type coordinate input device detects the intensity level of the light beam received through a light-receiving optical waveguide, to thereby recognize the coordinates of the object in the coordinate input area.

However, according to the above-mentioned optical coordinate input device of U.S. Pat. No. 5,914,709, a misoperation may occur in a case where two objects, of which coordinates have been detected in the coordinate input area, move simultaneously while shielding light beams. Under such a situation, an optical coordinate input device has been desired which will not cause a misoperation in detecting the coordinates of two objects even when the two objects move simultaneously in a coordinate input area.

### SUMMARY OF THE INVENTION

The present invention has been made to solve the above problem and the object thereof is to provide a display system having a coordinate input device capable of recognizing the coordinates of two objects accurately even when the two objects move in a rectangular coordinate input area.

In order to achieve the above object, there is provided a display system including: an optical coordinate input device including: a light emitting part including: a plurality of first light emitting devices arranged along a first side defining a part of a rectangular coordinate input area; and a plurality of second light emitting devices arranged along a second side perpendicular to the first side; a light receiving part including: a plurality of first light receiving devices for receiving light beams emitted from the plurality of first light emitting devices, each of the plurality of first light receiving devices being arranged so as to oppose to each of the plurality of first light emitting devices and arranged along a third side opposing to the first side; and a plurality of second light receiving devices for receiving light beams emitted from the plurality of second light emitting devices, each of the plurality of second light receiving devices being arranged so as to oppose to each of the plurality of second light emitting devices and arranged along a fourth side opposing to the second side, wherein, when light shielding signals are detected through one of the plurality of first light receiving devices and one of the plurality of second light receiving devices, the optical coordinate input device inputs a position coordinate of an intersection point where a light beam emitted from one of the plurality of first light emitting devices corresponding to the one of the plurality of first light receiving devices and a light beam emitted from one of the plurality of second light emitting devices corresponding to the one of the plurality of second light receiving devices intersect; a display device having a display screen on which the optical coordinate input device is arranged, the display device including: a signal processing device for calculating the position coordinate of the intersection point based on the light shielding signals detected through the one of the plurality of first light receiving devices and the one of the plurality of second light receiving devices; and a display control device for controlling to display position information on the display screen based on the position coordinate calculated by the signal processing device, wherein, in 10 ms or less, the signal processing device executes: a first process for obtaining initial position coordinates of two objects each of which is positioned on the display screen and shields a light beam from one of the plurality of first light emitting devices and a light beam from one of the plurality of second light emitting devices; a second process for obtaining a plurality of pair of light shielding signals detected through the plurality of first light receiving devices and the plurality of second light receiving devices based on that the two objects shield light beams from the plurality of first light emitting devices and light beams from the plurality of second light emitting devices after the two objects move on the display screen; and a third process for: calculating distances each of which represents a distance between one of the initial position coordinates of the two objects and a position coordinate specified by each pair of light shielding signals, the distance being calculated for each of all position coordinates specified by each pair of light shielding signals voluntarily selected among the plurality of pair of light shielding signals obtained in the second process; specifying such a pair of light shielding signals that the distance calculated becomes shortest; and setting a position coordinate determined based on the specified pair of light shielding signals as a position coordinate of each of the two objects after moving, and wherein the display control device executes a display process to display position information of each of the two objects on the display screen based on the position coordinate of each of the two objects after moving.

According to the display device having the optical coordinate input in the display system as configured above, in 10 ms or less, the signal processing device executes: a first process for obtaining initial position coordinates of two objects each of which is positioned on the display screen and shields a light beam from one of the plurality of first light emitting devices and a light beam from one of the plurality of second light emitting devices; a second process for obtaining a plurality of pair of light shielding signals detected through the plurality of first light receiving devices and the plurality of second light receiving devices based on that the two objects shield light beams from the plurality of first light emitting devices and light beams from the plurality of second light emitting devices after the two objects move on the display screen; and a third process for: calculating distances each of which represents a distance between one of the initial position coordinates of the two objects and a position coordinate specified by each pair of light shielding signals, the distance being calculated for each of all position coordinates specified by each pair of light shielding signals voluntarily selected among the plurality of pair of light shielding signals obtained in the second process; specifying such a pair of light shielding signals that the distance calculated becomes shortest; and setting a position coordinate determined based on the specified pair of light shielding signals as a position coordinate of each of the two objects after moving, and the display control device executes a display process to display position information of each of the two objects on the display screen based on the position coordinate of each of the two objects after moving. Accordingly, in a period of 10 ms which is the minimum period required for an ordinary operator to operate the objects, the respective distances from the initial position coordinates of the two objects to all the possible position coordinates based on the plurality of light shielding signals obtained in the signal obtaining process are calculated. Then, the combination of light shielding signals which makes the distance calculated in this manner the shortest is identified for each of the two objects. The position coordinates determined from thus-identified combinations of light shielding signals are defined as the respective position coordinates of the objects after moving. As a result, it is possible to accurately display the position information of the two objects which move in the coordinate input area simultaneously on the display screen.

### BRIEF DESCRIPTION OF THE DRAWINGS

FIG. 1 is an explanatory view of a display device having an optical coordinate input device attached thereto;

FIG. 2 is a schematic explanatory view of the front face of the optical coordinate input device;

FIG. 3 is a schematic cross-sectional view of the optical coordinate input device;

FIG. 4 is a schematic cross-sectional view of optical waveguides;

FIG. 5 is a flowchart of processes carried out by a signal processing unit and a display controlling unit;

FIG. 6 is a schematic explanatory view of a relationship among initial position coordinates of two objects, position coordinates of the two objects after moving and light shielding signals, in a case where the two objects move in a display screen 2; and

FIG. 7 is an explanatory view of an example of a modified display device.

### DETAILED DESCRIPTION OF THE. PREFERRED EMBODIMENTS

Hereinafter, an exemplary embodiment of a display device having an optical coordinate input device in a display system according to the present invention will be described in detail while referring to the drawings.

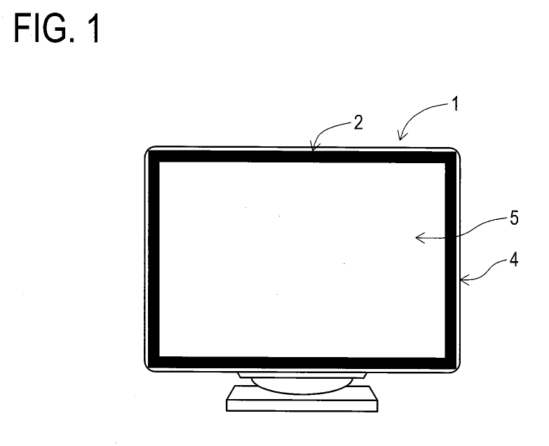

First, the schematic configuration of an optical coordinate input device and a display device according to the present embodiment will be described by referring to FIG. 1. FIG. 1 is an explanatory view of a display device having an optical coordinate input device attached thereto.

In FIG. 1, a display device 1 is constituted by a liquid crystal display panel, a plasma display panel or the like, and has a display screen 2 in front thereof. The display device 1 has a controller main body incorporated therein. On the display screen 2 of the display device 1, there is provided an optical coordinate input device 4, of which coordinate input area 5 is superimposed on the display area of the display screen 2. The coordinate input area 5 is arranged in front of the display screen 2.

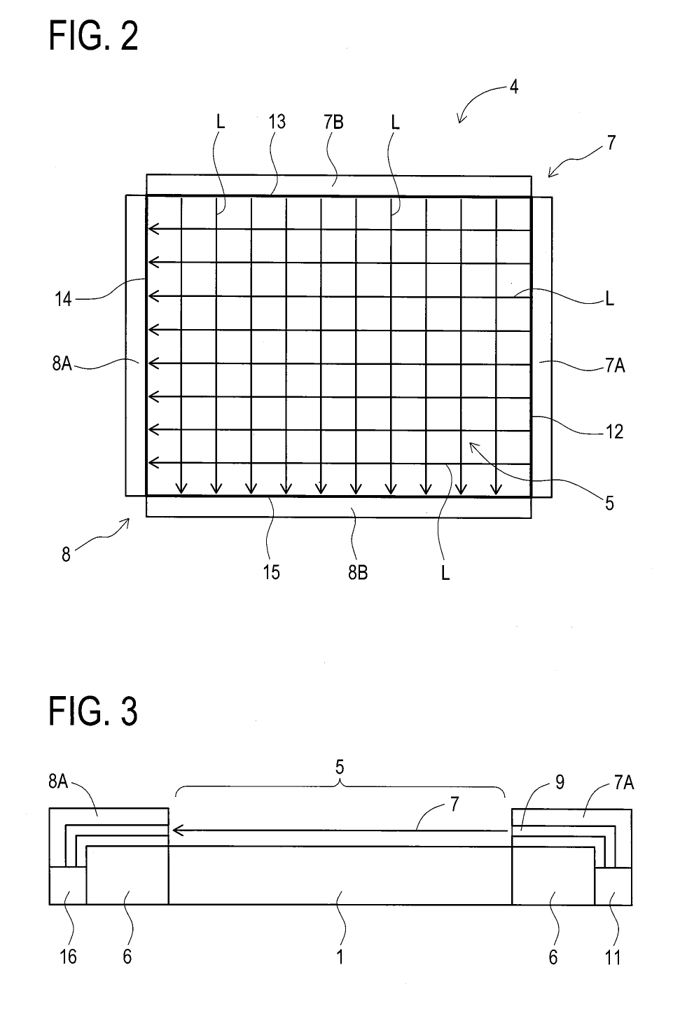

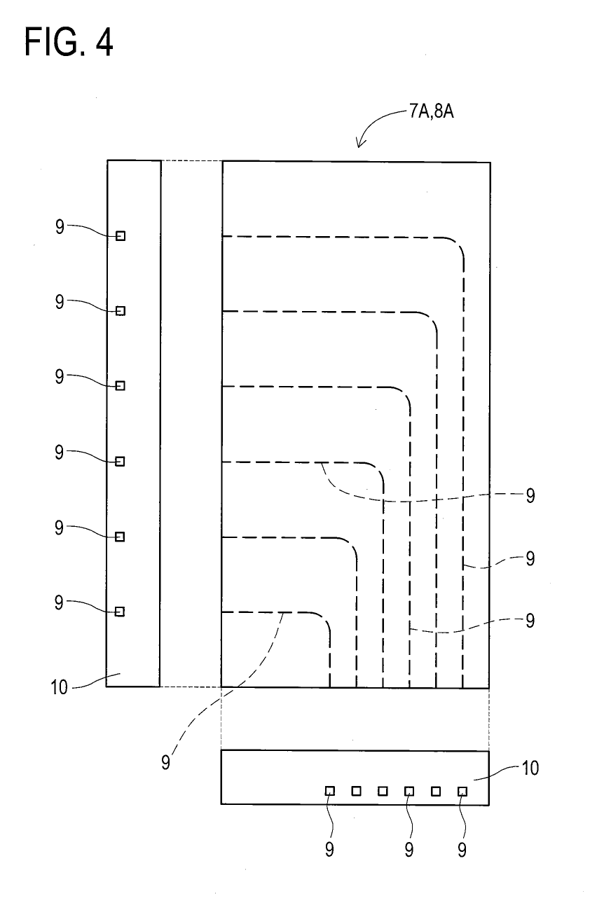

Next, the configuration of the optical coordinate input device 4 will be described by referring to FIGS. 2 to 4. FIG. 2 is a schematic explanatory view of the front face of an optical coordinate input device. FIG. 3 is a schematic cross-sectional view of the optical coordinate input device. FIG. 4 is a schematic cross-sectional view of optical waveguides.

As illustrated in FIGS. 2 to 4, the optical coordinate input device 4 includes a rectangular frame 6 fitted with the outer periphery of the display device 1 (see FIG. 3). On the top surface of the frame 6, there are arranged a light-emitting optical waveguide 7 and a light-receiving optical waveguide 8. The light-emitting optical waveguide 7 and the light-receiving optical waveguide 8 are both formed in L-shape, whereby the coordinate input area 5 is formed in a rectangular shape.

Here, the light-emitting optical waveguide 7 is constituted by a Y-side (vertical) light-emitting optical waveguide 7A and an X-side (horizontal) light-emitting optical waveguide 7B. Similarly, the light-receiving optical waveguide 8 is constituted by a Y-side (vertical) light-receiving optical waveguide 8A and an X-side light-receiving optical waveguide 8B. The Y-side light-emitting optical waveguide 7A and the X-side light-emitting optical waveguide 7B have basically the same configuration, and also the Y-side light-receiving optical waveguide 8A and the X-side light-receiving optical waveguide 8B have basically the same configuration. Hereafter, a description will be made by taking for example configurations of the Y-side light-emitting optical waveguide 7A and the Y-side light-receiving optical waveguide 8A.

As illustrated in FIG. 4, the Y-side light-emitting optical waveguide 7A arranged on the top surface of the frame 6 has a plurality of cores 9 (in the example of FIG. 2, eight cores), and a cladding layer 10 which covers and encloses the cores 9. A light-emitting element 11 is arranged at one ends of the cores 9 (in the example of FIG. 2, lower end portion) and the other ends of the cores 9 (in the example of FIG. 2, upper end portion) are guided to the edge of a light emitting Y-side 12.

Here, each of the cores 9 has a higher refractive index than that of the cladding layer 10 and is formed from a material having high transparency. A preferable material for forming the core 9 is an ultraviolet curing resin having excellent patterning capability. Incidentally, the width of the core 9 ranges, for instance, from 10 μm to 500 μm and the height of the core 9 ranges from 10 μm to 100 μm.

The cladding layer 10 is formed of a material with a lower refractive index than that of the core 9. Preferably, the difference between the maximum refractive indexes of the core 9 and the cladding layer 10 is 0.01, more preferably within the range from 0.02 to 0.2. A preferable material for forming the cladding layer 10 is an ultraviolet curing resin which is excellent in formability.

An optical waveguide constructed in this manner is manufactured by dry etching using plasma, a transfer method, an exposure and development method, a photobleaching method, and the like.

As the light-emitting element 11, a light emitting diode or a semiconductor laser may be employed, for instance, of which wavelength of light preferably ranges from 700 nm to 2500 nm.

It is to be noted that the X-side light-emitting optical waveguide 7B also has the same configuration as the Y-side light-emitting optical waveguide 7A as mentioned above, and the ends of the plurality of cores 9 (in the example of FIG. 2, ten cores) are guided to the edge of a light emitting X-side 13.

As illustrated in FIG. 4, the Y-side light-receiving optical waveguide 8A arranged on the top surface of the frame 6 has a plurality of cores 9 (in the example of FIG. 2, eight cores), and a cladding layer 10 which covers and encloses therein the cores 9. One ends of the cores 9 (in the example of FIG. 2, upper end portion) are aligned along the edge of a light-receiving Y-side 14 and a light-receiving element 16 is arranged at the other ends of the cores 9 (in the example of FIG. 2, lower end portion). The end faces of the cores 9 of the Y-side light-receiving optical waveguide 8A are arranged so as to be opposed to the respective end faces of the cores 9 of the Y-side light-emitting optical waveguide 7A.

The light-receiving element 16 serves to convert an optical signal into an electric signal and detect the intensity level of the light received.

This light-receiving element 16 has specific light-receiving ranges which are allocated to the respective cores 9 of the Y-side light-receiving optical waveguide 8A. This makes it possible to detect whether or not a light is received with respect to each of the cores 9 independently. The wavelength of light received by the light-receiving element 16 is preferably within the near-infrared region (700 nm to 2500 nm). An image sensor or a CCD image sensor is employed for this sort of light-receiving element 16.

It is to be noted that the X-side light-receiving optical waveguide 8B has the same configuration as the Y-side light-receiving optical waveguide 8A. However, one ends of the plurality of cores 9 (in the example of FIG. 2, ten cores) are aligned along the edge of a light-receiving X-side 15, and the light-receiving element 16 is arranged at the other ends of the cores 9. The end faces of the cores 9 of the X-side light-receiving optical waveguide 8B are arranged so as to be opposed to the respective end faces of the cores 9 of the X-side light-emitting optical waveguide 7B.

The light-receiving element 16 arranged at the X-side light-receiving optical waveguide 8B has specific light-receiving ranges which are allocated to the respective cores 9 of the X-side light-receiving optical waveguide 8B. This makes it possible to detect whether or not a light is received with respect to each of the cores 9 independently.

In the optical coordinate input device 4 configured as described above, when a light-emitting element 11 is turned on, the light therefrom is guided through the cores 9 of the Y-side light-emitting optical waveguide 7A and thereby light beams L are emitted from the end faces of the cores 9. These light beams L illuminate the end faces of the cores 9 of the Y-side light-receiving optical waveguide 8A. At the same time, the light beams L are guided through the cores 9 and received by a light-receiving element 16. Also, the light from another light-emitting element 11 is guided through the cores 9 of the X-side light-emitting optical waveguide 7B and thereby light beams L are emitted from the end faces of the cores 9. These light beams L illuminate the end faces of the cores 9 of the X-side light-receiving optical waveguide 8B. At the same time, the light beams L are guided through the cores 9 and received by another light-receiving element 16.

As described above, upon illumination of the light beams L from the cores 9 in the Y-side light-emitting optical waveguide 7A and the cores 9 in the X-side light-emitting optical waveguide 7B, a grid of light beams L is formed in an X-Y matrix on the coordinate input area 5, as illustrated in FIG. 2. When the display screen 2 is touched with objects such as fingers or pens in the coordinate input area 5, or the objects are moved thereon, the light beams L from the cores 9 in the Y-side light-emitting optical waveguide 7A and the cores 9 in the X-side light-emitting optical waveguide 7B are shielded at the respective intersection points thereof. Accordingly, both of the light-receiving elements 16 which receive lights from the respective cores 9 in the Y-side light-receiving optical waveguide 8A and the X-side light-receiving optical waveguide 8B, in light-receiving ranges corresponding to the light beams L shielded by the objects, do not receive lights. As a result, light shielding signals are detected by the individual light-receiving elements 16.

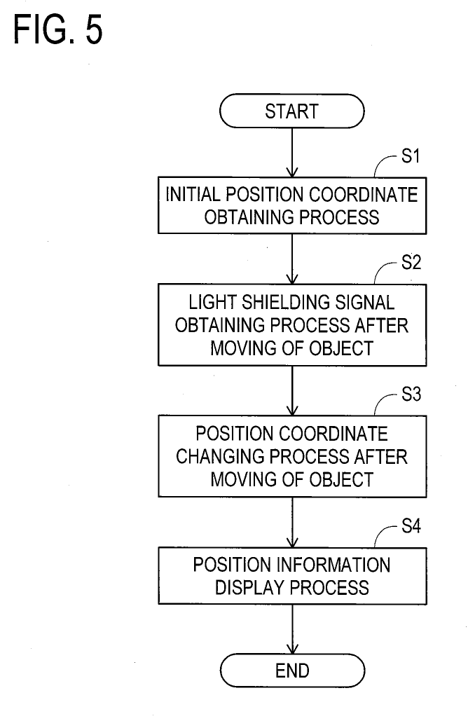

Next, processes carried out by a signal processing unit and a display controlling unit provided in the controller main body incorporated in the display device 1 will be described by referring to the flowchart of FIG. 5. FIG. 5 is a flowchart of processes carried out by the signal processing unit and the display controlling unit.

Here, the signal processing unit and the display controlling unit are typically constituted by a CPU (central processing unit), an FPGA (field programmable gate array) or the like, of which frequency of drive clock is 1 GHz, for instance.

First, at step (hereinafter referred to as “S”) 1 in FIG. 5, an initial position coordinate obtaining process is carried out. This initial position coordinate obtaining process will be described in detail.

If two objects in the coordinate input area 5 of the display screen 2 on the display device 1 shield light beams L emitted form the end faces of the cores 9 of the Y-side light-emitting optical waveguide 7A which are aligned along the edge of the light emitting Y-side 12, and light beams L emitted from the end faces of the cores 9 of the X-side light-emitting optical waveguide 7B which are aligned along the edge of the light emitting X-side 13, lights are not received by the light-receiving elements 16 through the end faces of the cores 9 of the Y-side light-receiving optical waveguide 8A aligned along the light-receiving Y-side 14 and the end faces of the cores 9 of the X-side light-receiving optical waveguide 8B aligned along the light-receiving X-side 15, in light-receiving ranges which respectively correspond to the shielded light beams L.

In this manner, at the time that lights are not received by respective light-receiving ranges in the light-receiving elements 16, the position coordinates of the two objects are obtained in the coordinate input area 5 in which the light beams L are formed in a matrix. These position coordinates are obtained as the respective initial position coordinates of the objects.

Here, the X-coordinate of each of the objects is defined with the X-coordinate of the line in the coordinate input area 5 that connects the end face of a core 9 corresponding to a light-receiving range in the light-receiving element 16 of the X-side light-receiving optical waveguide 8B, by which the light is not received, and the end face of an opposing core 9 of the X-side light-emitting optical waveguide 7B. The Y-coordinate of each of the objects is defined with the Y-coordinate of the line in the coordinate input area 5 that connects the end face of a core 9 corresponding to a light-receiving range in the light-receiving element 16 of the Y-side light-receiving optical waveguide 8A, by which the light is not received, and the end face of an opposing core 9 of the Y-side light-emitting optical waveguide 7A.

In other words, the coordinates of each of the objects are the coordinates of each intersection point of a line which connects the end face of a core 9 corresponding to a light-receiving range in the light-receiving element 16 of the X-side light-receiving optical waveguide 8B, by which the light is not received, and the end face of an opposing core 9 in the X-side light-emitting optical waveguide 7B, and a line which connects the end face of a core 9 corresponding to a light-receiving range in the light-receiving element 16 of the Y-side light-receiving optical waveguide 8A, by which the light is not received, and the end face of an opposing core 9 in the Y-side light-emitting optical waveguide 7A.

Next, at S2, a light shielding signal obtaining process after moving of the objects is carried out.

To be more specific, when the two objects have moved and stopped within the coordinate input area 5, the two objects shield, at their stopped positions, some of the light beams L emitted from the end faces of the cores 9 in the Y-side light-emitting optical waveguide 7A which are aligned along the edge of the light emitting Y-side 12 and the end faces of the cores 9 in the X-side light-emitting optical waveguide 7B which are aligned along the edge of the light emitting X-side 13. If the light beams L are shielded in this manner, the respective light-receiving elements 16 do not receive the lights through the end faces of the cores 9 of the Y-side light-receiving optical waveguide 8A which are aligned along the light-receiving Y-side 14 and the end faces of the cores 9 of the X-side light-receiving optical waveguide 8B which are aligned along the light-receiving X-side 15, in light-receiving ranges thereof which respectively correspond to the shielded lights.

At this time, a plurality of light shielding signals are obtained at light-receiving ranges in the light-receiving element 16 corresponding to the cores 9 in the Y-side light-receiving optical waveguide 8A and light-receiving ranges in the light-receiving element 16 corresponding to the cores 9 in the X-side light-receiving optical waveguide 8B.

Subsequently, at S3, a position coordinate changing process after moving of objects is carried out.

To be more specific, all the possible position coordinates with respect to each of the two objects after their moving are obtained, based on the plurality of light shielding signals obtained in the above light shielding signal obtaining process at S2. Then, based on the initial position coordinate of one of the objects obtained at above S1 and all the possible position coordinates obtained with respect to the objects after their moving, distances between the initial position coordinate and the possible position coordinates after their moving are calculated respectively. Further, a combination of the light shielding signals which makes the distance between the two position coordinates calculated in the above manner the shortest is specified, and a position coordinate determined from thus-specified combination of the light shielding signals is defined as the position coordinate of the one of the objects after moving.

At S4, a position information display process of the objects is carried out.

To be more specific, based on the position coordinates of the objects after their moving obtained at S3 as described above, the position information of the objects are displayed on the display screen 2 by the display controlling unit.

In the display device 1 having the optical coordinate input device 4 according to the present embodiment, the processes of S1 through S4 as described above are carried out in a period of 10 milliseconds (ms) or less. This period of 10 ms is an extremely short period of time. When an ordinary operator moves two objects, such as the two fingers, in the coordinate input area 5 of the optical coordinate input device 4, the operation time usually exceeds 10 ms. Therefore, for determining the moving distance of each of the two objects, it is sufficient to consider the shortest distance detected.

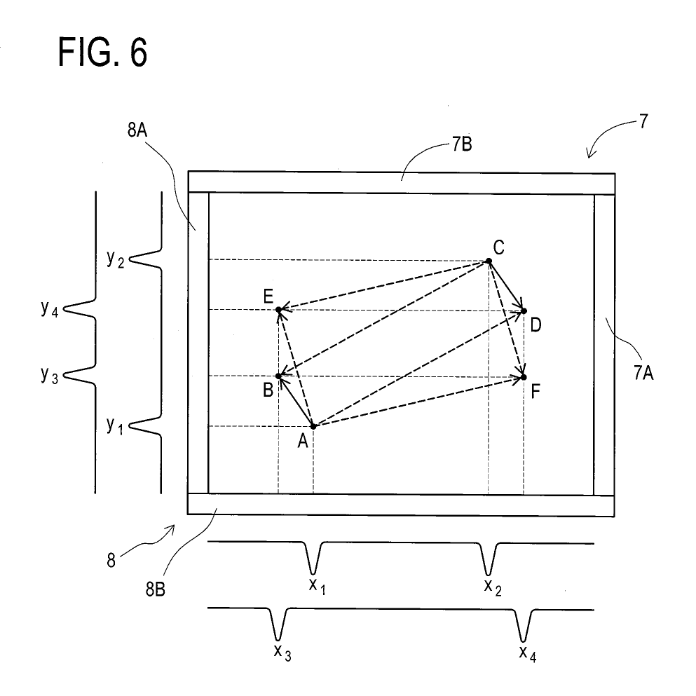

Here, the processes of S1 through S4 will be described in detail by referring to FIG. 6. FIG. 6 is a schematic explanatory view of a relationship among initial position coordinates of two objects, position coordinates of the two objects after their moving and light shielding signals, in a case where the two objects move on the display screen 2.

In FIG. 6, the two objects are respectively positioned at points A and C before moving. At this time, a light beam L from the X-side light-receiving optical waveguide 8B corresponding to a coordinate x1 and a light beam from the Y-side light-receiving optical waveguide 8A corresponding to a coordinate y1 are shielded by the object positioned at the point A, in accordance with which a light shielding signal is generated at each of the coordinates x1 and y1. Thus, the initial position coordinate of the object positioned at the point A is (x1, y1).

A light beam L from the X-side light-receiving optical waveguide 8B corresponding to a coordinate x2 and the light beam L from the Y-side light-receiving optical waveguide 8A corresponding to a coordinate y2 are shielded by the object positioned at the point C, in accordance with which a light shielding signal is generated at each of the coordinates x2 and y2. Thus, the initial position coordinate of the object positioned at the point C is (x2, y2).

As described above, at S1, the initial position coordinate of the object positioned at the point A, (x1, y1), is obtained and the initial position coordinate of the object positioned at the point C, (x2, y2), is obtained.

Next, a case will be described where the object at the point A and the object at the point C move in the coordinate input area 5 simultaneously. After the object at the point A and the object at the point C move, similarly to the case as described above, the objects selectively shield light beams L from the cores 9 of the X-side light-emitting optical waveguide 7B and light beams L from the cores 9 of the Y-side light-emitting optical waveguide 7A. Accordingly, all of plurality of light shielding signals are obtained which are detected through the cores 9 and the light-receiving element 16 of the X-side light-receiving optical waveguide 8B, and the cores 9 and the light-receiving element 16 of the Y-side light-receiving optical waveguide 8A.

For example, in FIG. 6, light shielding signals are obtained at a coordinate x3 and a coordinate x4 through their respective corresponding cores 9 and the light-receiving element 16 of the X-side light-receiving optical waveguide 8B, and light shielding signals are obtained at a coordinate y3 and a coordinate y4 through their respective corresponding cores 9 and the light-receiving element 16 of the Y-side light-receiving optical waveguide 8A.

In the manner as described above, at S2, when the object at the point A and the object at the point C move in the coordinate input area 5 simultaneously, all of plurality of light shielding signals are obtained which are detected through the cores 9 and the light-receiving element 16 of the X-side light-receiving optical waveguide 8B, and the cores 9 and the light-receiving element 16 of the Y-side light-receiving optical waveguide 8A.

Next, the possible points within the coordinate input area 5 are determined based on the coordinates x3 and x4 and the coordinates y3 and y4, which are obtained according to the light shielding signals in the manner as described above. Here, possible combinations of the coordinates are (x3, y3), (x3, y4), (x4, y3), and (x4, y4), which are hereinafter referred to as point B (x3, y3), point E (x3, y4), point F (x4, y3) and point D (x4, y4), respectively.

Next, the distances from the initial position coordinate of the object positioned at the point A (x1, y1) are respectively calculated, to the point B (x3, y3), the point E (x3, y4), the point F (x4, y3) and the point D (x4, y4). At the same time, the distances from the initial position coordinate of the object positioned at the point C (x2, y2) are respectively calculated, to the point B (x3, y3), the point E (x3, y4), the point F (x4, y3) and the point D (x4, y4).

To be more specific, the respective distances can be calculated in the following manner, wherein, with respect to the point A, the distance to the point B is defined as PAB, the distance to the point E is defined as PAE, the distance to the point D is defined as PAD, and the distance to the point F is defined as PAF.

PAB=[(x3−x1)²+(y3−y1)^{2]}^{1/2}

PAE=[(x3−x1)²+(y4−y1)²+(y4−y1)²]^{1/2}

PAD=[(x4−x1)²+(y4−y1)²]^{1/2}

PAF=[(x4−x1)²+(y3+y1)^{2]}^{1/2}

From among the distances obtained by calculating as above, PAB is the shortest distance. As a result, the combination of the light shielding signals which makes the distance thereof the shortest is of the light shielding signal obtained at the coordinate x3 and the light shielding signal obtained at the coordinate y3. In accordance with the combination of these light shielding signals, a position coordinate (x3, y3) is identified. Then, this position coordinate (x3, y3) is determined as the position coordinate after moving of the object initially positioned at the point A. This means that the object has moved from the point A to the point B.

Based on the fact that the object has moved from the point A to the point B, the position coordinate of the object at the point C after moving is automatically determined from the position coordinates of the remaining points, that is, the point D (x4, y4) is obtained.

As a result, with respect to the point C, the combination of light shielding signals which makes the distance after moving the shortest is of the light shielding signal obtained at the coordinate x4 and the light shielding signal obtained at the coordinate y4. In accordance with the combination of these light shielding signals, a position coordinate (x4, y4) is identified. Then, this position coordinates (x4, y4) is determined as the position coordinate after moving of the object initially positioned at the point C. This means that the object has moved from the point C to the point D.

As described above, at S3, the respective distances between the initial position coordinates of the two objects and all the selectable position coordinates based on the plurality of light shielding signals obtained at S2, that is, the distances from (x1, y1) to (x3, y3), (x3, y4), (x4, y3) and (x4, y4) and the distances from (x2, y2) to (x3, y3), (x3, y4), (x4, y3) and (x4, y4) are respectively calculated. Then, the combinations of light shielding signals which make thus-calculated distances the shortest are identified, whereby the position coordinates (x3, y3) and (x4, y4) determined from the identified combinations of light shielding signals are defined as the position coordinates of the two objects after moving.

Subsequently, the display controlling unit displays the position information for indicating the objects on the display screen 2, based on the position coordinates (x3, y3) and (x4, y4) of the objects after moving which are obtained as described above. More precisely, on the display screen 2, the display controlling unit displays the position information so that one of the objects appears to move from the point A to point B and the other object to move from the point C to point D. These processes are carried out at S4 as described above.

As described above in detail, according to the display device 1 having the optical coordinate input device 4 in a display system directed to the present embodiment, in a period of 10 ms or less, the signal processing unit carries out the initial coordinate obtaining process (S1), the light shielding signal obtaining process (S2) and the position coordinate changing process (S3), and the display controlling unit carries out the display process (S4). In the initial coordinate obtaining process (S1), the signal processing unit obtains the coordinates of the two objects on the display screen 2 and shield the light beams L from the respective cores 9 in the Y-side light-emitting optical waveguide 7A and the X-side light-emitting optical waveguide 7B as the initial position coordinates (x1, y1) and (x2, y2). In the light shielding signal obtaining process (S2), when the two objects move on the display screen 2, the signal processing unit obtains a plurality of light shielding signals which are detected through the respective cores 9 and the light-receiving elements 16 of the Y-side light-receiving optical waveguide 8A and the X-side light-receiving optical waveguide 8B in accordance with shielding of the light beams L from the respective cores 9 in the Y-side light-emitting optical waveguide 7A and the X-side light-emitting optical waveguide 7B by the two objects after moving. In the position coordinate changing process (S3), the signal processing unit calculates the respective distances from the initial position coordinates (x1, y1) and (x2, y2) of the two objects, to all the possible position coordinates (x3, y3), (x3, y4), (x4, y3) and (x4, y4) based on the plurality of light shielding signals obtained in the signal obtaining process. Then, the signal processing unit identifies a combination of light shielding signals which makes the distance therebetween the shortest for each of the objects, and defines the position coordinates (x3, y3) and (x4, y4) determined from thus-identified combinations of light shielding signals as the position coordinates of the objects after moving. In the display process (S4), the display controlling unit displays the position information of the objects on the display screen 2, based on the position coordinates of the objects after moving. Accordingly, in a period of 10 ms which is the minimum period required for an ordinary operator to operate the objects, the respective distances from the initial position coordinates of the two objects (x1, y1) and (x2, y2), to all the possible position coordinates based on the plurality of light shielding signals obtained in the signal obtaining process are calculated. Then, the combination of light shielding signals which makes the distance calculated in this manner the shortest is identified for each of the two objects. The position coordinates (x3, y3) and (x4, y4) determined from thus-identified combinations of light shielding signals are defined as the respective position coordinates of the objects after moving. As a result, it is possible to accurately display the position information of the two objects which move in the coordinate input area 5 simultaneously on the display screen 2.

It is needless to say that the present invention is not limited to the above-described embodiment but may be variously improved and modified without departing from the scope of the present invention.

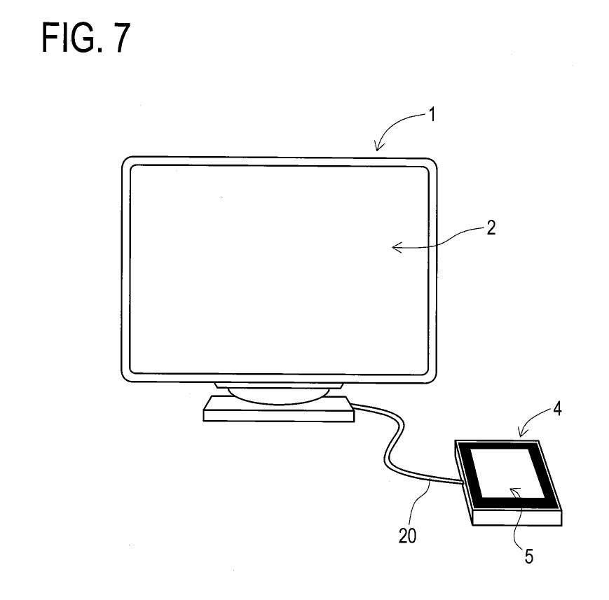

For instance, in the above-described embodiment, the optical coordinate input device 4 is configured to be arranged in the display device 1. However, without being limited to this configuration, the optical coordinate input device 4 may be connected to a display device 1 with a built-in controller main body via a USB cable 20, as shown in FIG. 7.

What is claimed is:

1. A display system comprising:
an optical coordinate input device comprising:
a light emitting part including:
a plurality of first light emitting devices arranged along a first side defining a part of a rectangular coordinate input area; and
a plurality of second light emitting devices arranged along a second side perpendicular to the first side;
a light receiving part including:
a plurality of first light receiving devices for receiving light beams emitted from the plurality of first light emitting devices, each of the plurality of first light receiving devices being arranged so as to oppose to each of the plurality of first light emitting devices and arranged along a third side opposing to the first side; and
a plurality of second light receiving devices for receiving light beams emitted from the plurality of second light emitting devices, each of the plurality of second light receiving devices being arranged so as to oppose to each of the plurality of second light emitting devices and arranged along a fourth side opposing to the second side,
wherein, when light shielding signals are detected through one of the plurality of first light receiving devices and one of the plurality of second light receiving devices, the optical coordinate input device inputs a position coordinate of an intersection point where a light beam emitted from one of the plurality of first light emitting devices corresponding to the one of the plurality of first light receiving devices and a light beam emitted from one of the plurality of second light emitting devices corresponding to the one of the plurality of second light receiving devices intersect;
a display device having a display screen on which the optical coordinate input device is arranged, the display device comprising:
a signal processing device for calculating the position coordinate of the intersection point based on the light shielding signals detected through the one of the plurality of first light receiving devices and the one of the plurality of second light receiving devices; and
a display control device for controlling to display position information on the display screen based on the position coordinate calculated by the signal processing device,
wherein, in 10 ms or less, the signal processing device executes:
a first process for obtaining initial position coordinates of two objects each of which is positioned on the display screen and shields a light beam from one of the plurality of first light emitting devices and a light beam from one of the plurality of second light emitting devices;
a second process for obtaining a plurality of pair of light shielding signals detected through the plurality of first light receiving devices and the plurality of second light receiving devices based on that the two objects shield light beams from the plurality of first light emitting devices and light beams from the plurality of second light emitting devices after the two objects move on the display screen; and
a third process for:
calculating distances each of which represents a distance between one of the initial position coordinates of the two objects and a position coordinate specified by each pair of light shielding signals, the distance being calculated for each of all position coordinates specified by each pair of light shielding signals voluntarily selected among the plurality of pair of light shielding signals obtained in the second process;
specifying such a pair of light shielding signals that the distance calculated becomes shortest; and
setting a position coordinate determined based on the specified pair of light shielding signals as a position coordinate of each of the two objects after moving, and
wherein the display control device executes a display process to display position information of each of the two objects on the display screen based on the position coordinate of each of the two objects after moving.

2. The display system according to claim 1, wherein the light emitting part comprises:
one light emitting element; and
a first light waveguide including a plurality of light guide members arranged so that one ends of the plurality of light guide members are converged near the one light emitting element, a part of other ends of the plurality of light guide members being arranged along the first side and remaining other ends of the plurality of light guide members being arranged along the second side.

3. The display system according to claim 1, wherein the light receiving part comprises:
a second light waveguide including a plurality of light guide members, a part of one ends of the plurality of light guide members being arranged along the third side and remaining one ends of the plurality of light guide members being arranged along the fourth side and other ends of the plurality of light guide members being converged and connected to a light receiving element.
